(19) United States
(12) Patent Application Publication
(10) Pub. No.: US 2016/0299384 A1
(43) Pub. Date: Oct. 13, 2016

(54) LIQUID CRYSTAL DISPLAY DEVICE

(71) Applicant: Samsung Display Co., Ltd., Yongin-si (KR)

(72) Inventors: Jang Mi KANG, Bucheon-si (KR); Kwang-Chul JUNG, Seongnam-si (KR); Cheol-Gon LEE, Seoul (KR); Mee Hye JUNG, Suwon-si (KR)

(21) Appl. No.: 14/850,653

(22) Filed: Sep. 10, 2015

(30) Foreign Application Priority Data
Apr. 8, 2015 (KR) 1020150049660

(51) Int. Cl. G02F 1/1343; G02F 1/1335; G02F 1/1333; G02F 1/1368; G02F 1/1362

(52) U.S. Cl. CPC G02F 1/134309; G02F 1/1368; G02F 1/136286; G02F 1/133377; G02F 1/13624; G02F 1/133514; G02F 2001/134345

(57) ABSTRACT

According to one embodiment, a liquid crystal display device includes a substrate, a thin film transistor connected to a gate line and a data line that are insulated and intersected on the substrate, a pixel electrode including a first subpixel electrode and a second subpixel electrode that are connected to the thin film transistor, and a common electrode that is spaced apart from the pixel electrode with a plurality of microcavities. The plurality of microcavities are disposed on the pixel electrode and interposed between the common electrode and the pixel electrode. The liquid crystal display further includes a roof layer disposed on the common electrode, and a liquid crystal layer that includes liquid crystal molecules filing the microcavities. The common electrode includes a first common electrode and a second common electrode. Voltages applied to the first common electrode and the second common electrode are different from each other.

### CROSS-REFERENCE TO RELATED APPLICATION

This application claims priority to and the benefit of Korean Patent Application No. 10-2015-0049660 filed in the Korean Intellectual Property Office on Apr. 8, 2015, which is incorporated herein by reference in its entirety.

### BACKGROUND

(a) Field

The present disclosure relates to a liquid crystal display device.

(b) Description of the Related Art

A liquid crystal display (LCD) device is one of flat panel display devices that are widely used at present. The liquid crystal display device includes two display panels on which electric field generating electrodes such as pixel electrodes and common electrodes are disposed, and a liquid crystal layer interposed therebetween. The liquid crystal display device generates electric fields in the liquid crystal layer by applying voltage to the field generating electrodes, and changes the orientation of liquid crystal molecules in the liquid crystal layer by the generated electric fields to control polarization of incident light to display images.

The liquid crystal display device may include a thin film transistor display panel and an opposing display panel. On the thin film transistor display panel, various components including, but not limited to, a gate line, a data line, a thin film transistor, and a pixel electrode are disposed. The gate line is configured to transmit a gate signal, and the data line intersecting with the gate line is configured to transmit a data signal. The thin film transistor is connected to the gate line and the data line, and the pixel electrode is connected to the thin film transistor. On the opposing display panel, a light blocking member, a color filter, and a common electrode are disposed. In some cases, the light blocking member, the color filter, and the common electrode may be disposed on the thin film transistor display panel.

The above information disclosed in the Background is only for enhancement of understanding of the background of the present disclosure and therefore it may contain information that does not form the prior art that is already known to a person of ordinary skill in the art.

### SUMMARY

According to one embodiment, a pixel is divided into two subpixels and different voltages are applied to the two subpixels to improve a side visibility.

An exemplary embodiment of the present disclosure provides a liquid crystal display device including a substrate, a thin film transistor connected to a gate line and a data line that are insulated and intersected on the substrate, a pixel electrode including a first subpixel electrode and a second subpixel electrode that are connected to the thin film transistor, a common electrode which are spaced apart from the pixel electrode with a plurality of microcavities. The plurality of microcavities are disposed on the pixel electrode and interposed between the common electrode and the pixel electrode. The liquid crystal display device further includes a roof layer disposed on the common electrode, and a liquid crystal layer that includes liquid crystal molecules filing the microcavities, wherein the common electrode includes a first common electrode and a second common electrode, and a voltage applied to the first common electrode and a voltage applied to the second common electrode are different from each other.

The first common electrode and the second common electrode may be extended in a row direction. The first common electrode and the second common electrode may be alternatively disposed in a column direction. The thin film transistor may include a first thin film transistor, a second thin film transistor and a third thin film transistor that is connected to the second thin film transistor, and the first subpixel electrode may be connected to the first thin film transistor and the second subpixel electrode may be connected to the second thin film transistor. A first common voltage may be applied to the first common electrode and a second common voltage may be applied to the second common voltage, and the first common voltage may be greater than the second common voltage. The first subpixel electrode and the first common electrode form a first liquid crystal capacitor, and the first subpixel electrode and the second common electrode form a second liquid crystal capacitor, and a charging value of the second liquid crystal capacitor may be greater than that of the first liquid crystal capacitor. The second subpixel electrode and the first common electrode form a third liquid crystal capacitor, and the second subpixel electrode and the second common electrode form a fourth liquid crystal capacitor, and a charging value of the fourth liquid crystal capacitor may be greater than that of the third liquid crystal capacitor. The first common voltage and the second common voltage may be applied to the first common electrode and the second common electrode alternatively.

The liquid crystal display device may further include a color filter, a gate insulating layer disposed on the gate line, a first passivation layer disposed on the data line, a second passivation layer disposed on the common electrode, and a third passivation layer disposed on the color filter. At least one of the second passivation layer and the third passivation layer may be made of a silicon nitride, a silicon oxide and a silicon nitride oxide.

The liquid crystal display device further includes an encapsulation layer. The common electrode and the roof layer have an injection hole configured to expose a part of the plurality of microcavities and the encapsulation layer is disposed on the roof layer and is configured to cover the injection hole and seal the microcavities.

The plurality of microcavities may be arranged in a form of a matrix, and a first valley may be positioned between two adjacent rows of the plurality of microcavities. Each of the first subpixel electrode and the second subpixel electrode may include a cruciform stem part, and a plurality of minute branch parts extended therefrom and the common electrode may be in a plane shape.

According to the exemplary embodiments described above, a liquid crystal display device with an improved side visibility design is provided.

### BRIEF DESCRIPTION OF THE DRAWINGS

FIG. 1 is a top plan view of a liquid crystal display device according to an exemplary embodiment of the present disclosure.

FIG. 2 is a layout view of a pixel of a liquid crystal display device according to an exemplary embodiment of the present disclosure.

FIG. 3 is a cross-sectional view taken along a line III-III of the liquid crystal display device of FIG. 1.

FIG. 4 is a cross-sectional view taken along a line IV-IV of the liquid crystal display device of FIG. 1.

FIG. 5 and FIG. 6 are transmittance graphs according to an exemplary embodiment of the present disclosure.

FIG. 7 and FIG. 8 are transmittance graphs according to a comparative example.

### DETAILED DESCRIPTION

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity and illustrative purposes, thus may not be scaled. It will be understood that when an element or layer is referred to as being “on,” “connected to” or “coupled to” another element or layer, it may be directly on, connected or coupled to the another element or layer, or one or more intervening elements or layers may be present therebetween. In contrast, when an element is referred to as being “directly on,” “directly connected to” or “directly coupled to” another element or layer, there may be no intervening elements or layers present therebetween. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer, pattern, or section from another element, component, region, layer, pattern, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of a device in use or operation in addition to the described and depicted orientation in the specification and figures. For example, if the device as illustrated in a figure is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein are interpreted accordingly.

The terminology used herein is for the purpose of describing particular example embodiments only and is not intended to be limiting of the present disclosure. As used herein, the singular forms “a,” “an,” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of a relevant art and will not be interpreted in an idealized or overly formal sense unless expressly so defined herein.

A liquid crystal display device generally includes two substrates on which constituent elements are disposed causing the liquid crystal display device to be heavy and thick. In addition, there are other drawbacks such as a high manufacturing cost and a long processing time. A liquid crystal display device that uses a vertically aligned (VA) mode may have an inferior side visibility as compared to a front visibility.

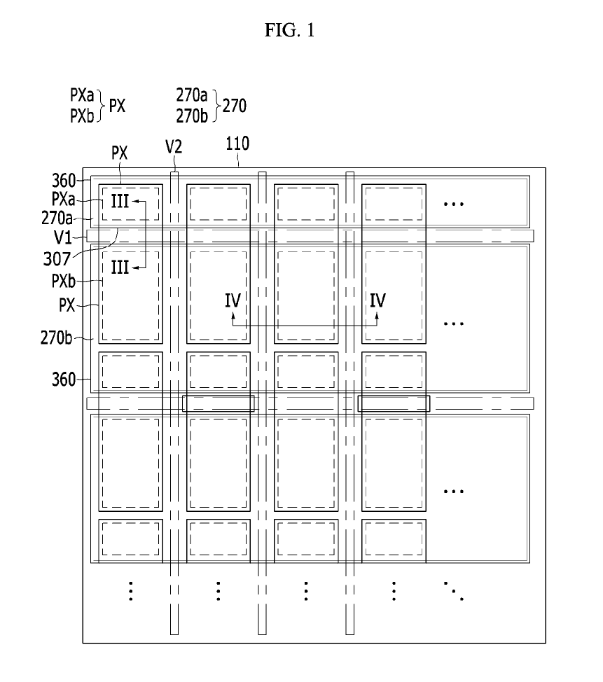

Hereinafter, an exemplary embodiment of a liquid crystal display device according to the present disclosure will be described in detail with reference to FIG. 1 to FIG. 4.

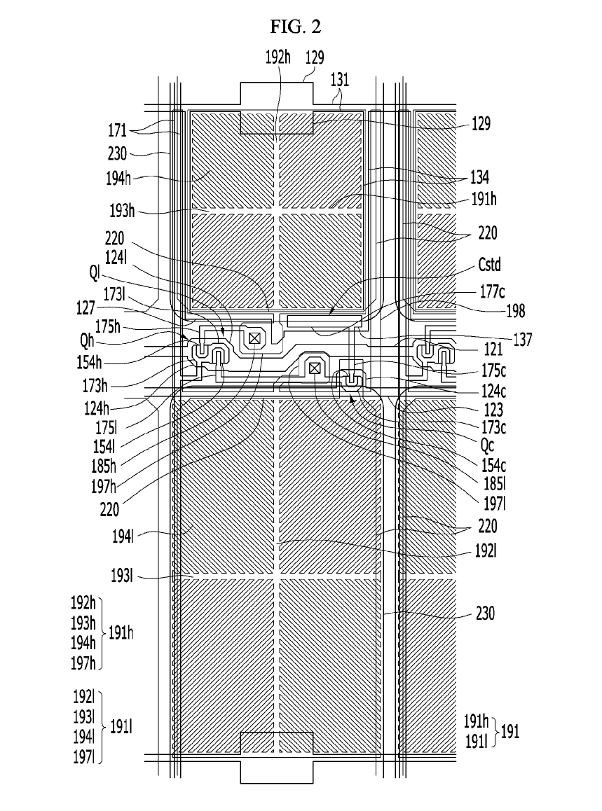

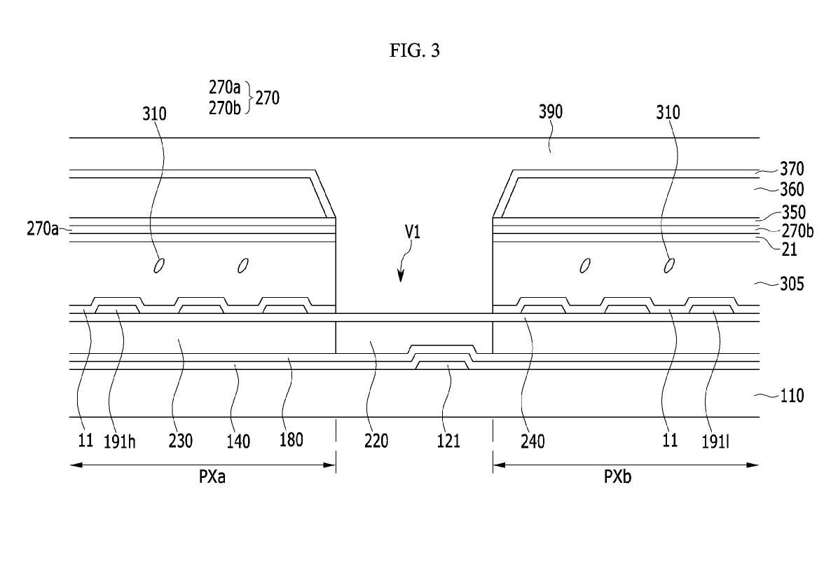

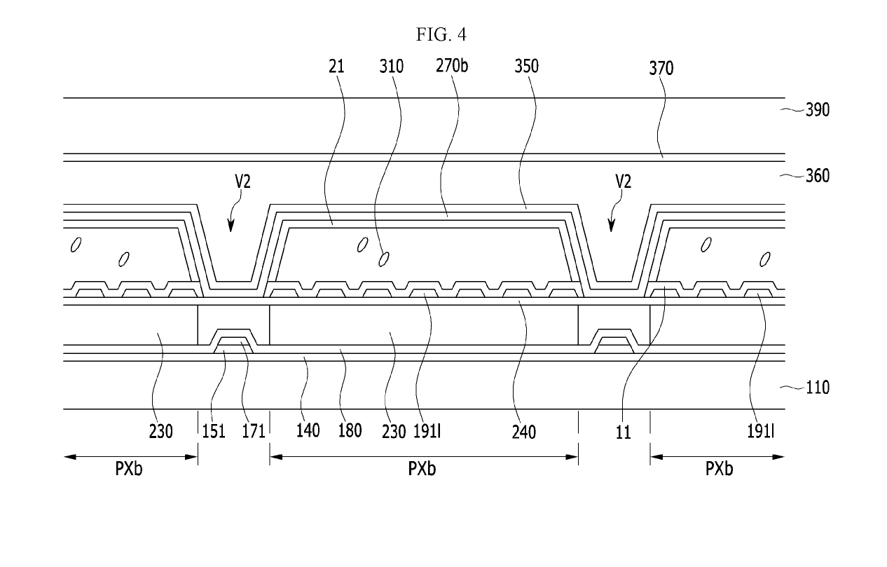

FIG. 1 is a top plan view of a liquid crystal display device according to an exemplary embodiment of the present disclosure. FIG. 2 is a layout view of a pixel of a liquid crystal display device according to an exemplary embodiment of the present disclosure. FIG. 3 is a cross-sectional view taken along a line III-III of the liquid crystal display device of FIG. 1. FIG. 4 is a cross-sectional view taken along a line IV-IV of the liquid crystal display device of FIG. 1.

A liquid crystal display device according to an exemplary embodiment of the present disclosure includes a substrate 110 that may be made of a glass or a plastic, or the like, and a plurality of roof layers 360 disposed on the substrate 110. The substrate 110 includes a plurality of pixel areas PXs that are arranged in a form of a matrix including a plurality of pixel rows and a plurality of pixel columns. Each of pixel areas PXs includes a first subpixel area PXa, and a second subpixel area PXb. The first subpixel area PXa and the second subpixel area PXb may be arranged in a pixel column direction.

A plurality of first valleys V1 are extended along the direction of the pixel rows, and each of the first valleys V1 is positioned between the first subpixel area PXa and the second subpixel area PXb. A plurality of second valleys V2 are extended along the direction of the pixel columns, and each of the second valleys V2 is positioned between two adjacent pixel columns.

The roof layers 360 are disposed in the pixel row direction. An injection hole 307 is formed by removing the roof layer 360 in the first valley V1 so that constituent elements positioned under the roof layer 360 are exposed.

The roof layers 360 are spaced apart from the substrate 110 at the adjacent second valleys V2 to form a microcavity 305. In addition, the roof layers 360 are protruded toward the substrate 110 at the second valleys V2 to block both sides of the microcavity 305.

The aforementioned structure of the display device according to an embodiment is merely an example, and various modifications may be made. For example, the disposition configuration of the pixel area PX, the first valleys V1 and the second valleys V2 may be changed, the plurality of roof layers 360 may be connected to each other at the first valleys V1, and a portion of the roof layers 360 may be separated from the substrate 110 at the second valleys V2, thereby making the adjacent microcavities 305 to be connected to each other.

Referring to FIGS. 1-4, a gate conductor including a plurality of gate lines 121, a plurality of step-down gate lines 123, and a plurality of storage electrode lines 131 is disposed on the substrate 110. The gate line 121 and the step-down gate line 123 are mainly extended in a horizontal direction and transmit gate signals. The gate conductor further includes a first gate electrode 124h and a second gate electrode 124l. The first gate electrode 124h upwardly protrudes from the gate line 121 and the second gate electrode 124l downwardly protrudes from the gate line 121. The gate conductor further includes a third gate electrode 124c that protrudes upward from the step-down gate line 123. The first gate electrode 124h and the second gate electrode 124l are connected to each other to form a single protruding portion. The protruding configuration of the first, second, and third gate electrodes 124h, 124l, and 124c may be formed differently without deviating from the scope of the present disclosure.

The storage electrode line 131 is mainly extended in the horizontal direction, and transmits a predetermined voltage such as a common voltage Vcom. The storage electrode line 131 includes a storage electrode 129 that protrudes upward and downward, a pair of vertical portions 134 that is extended downward to be substantially perpendicular to the gate line 121, and a horizontal portion 127 that connects ends of the pair of vertical portions 134 to each other. The horizontal portion 127 includes a capacitor electrode 137 that is enlarged downward.

A gate insulating layer 140 is disposed on the gate conductors including the gate line 121, the step-down gate line 123, the first gate electrode 124h, the second gate electrode 124l, the third gate electrode 124c, and the storage electrode line 131. The gate insulating layer 140 may be made of an inorganic insulating material such as a silicon nitride (SiNx) and a silicon oxide (SiOx). In addition, the gate insulating layer 140 may be formed as a single layer or multilayer.

A first semiconductor 154h, a second semiconductor 154l and a third semiconductor 154c are disposed on the gate insulating layer 140. The first semiconductor 154h may be disposed on the first gate electrode 124h, the second semiconductor 154l may be disposed on the second gate electrode 124l, and the third semiconductor 154c may be disposed on the third gate electrode 124c. The first semiconductor 154h and the second semiconductor 154l may be connected to each other, and the second semiconductor 154l and the third semiconductor 154c may be connected to each other. In addition, the first semiconductor 154h may be disposed to be extended to a lower side of the data line 171. The first, second, and third semiconductors 154h, 154l, and 154c may be made of amorphous silicon, polysilicon, metal oxide, or the like.

An ohmic contact (not illustrated) may be further disposed on each of the first, second, and third semiconductors 154h, 154l, and 154c. The ohmic contact may be made of a material such as n+ hydrogenated amorphous silicon doped with silicide or n-type impurity at high concentration.

A data conductor including a data line 171, a first source electrode 173h, a second source electrode 173l, a third source electrode 173c, a first drain electrode 175h, a second drain electrode 175l, and a third drain electrode 175c is disposed on the first, second and third semiconductors 154h, 154l and 154c. The data line 171 transmits a data signal, and is mainly extended in the vertical direction to intersect the gate line 121 and the step-down gate line 123. The data line 171 includes the first source electrode 173h and the second source electrode 173l that are extended toward the first gate electrode 124h and the second gate electrode 124l and connected to each other.

Each of the first drain electrode 175h, the second drain electrode 175l, and the third drain electrode 175c includes two end portions including a wide end portion and a bar-shaped end portion. The bar-shaped end portion of the first drain electrode 175h is partially enclosed by the first source electrode 173h and the bar-shaped end portion of the second drain electrode 175; are partially enclosed by the second source electrode 173l. The third source electrode 173c is extended from the wide end portion of the second drain electrode 175l and has a “U” shape. A wide end portion 177c of the third drain electrode 175c is overlapped with the capacitor electrode 137 to form a step-down capacitor (Cstd), and the bar-shaped end portion of third drain electrode 175c is partially enclosed by the third source electrode 173c.

The first gate electrode 124h, the first source electrode 173h, and the first drain electrode 175h form a first thin film transistor Qh along with the first semiconductor 154h. The second gate electrode 124l, the second source electrode 173l, and second drain electrode 175l form a second thin film transistor Ql along with the second semiconductor 154l. The third gate electrode 124c, the third source electrode 173c, and the third drain electrode 175c form a third thin film transistor Qc along with the third semiconductor 154c.

The first semiconductor 154h, the second semiconductor 154l, and the third semiconductor 154c may be connected to each other to form a linear shape and may have substantially the same plane shape with the data conductor including the data line 171, the first source electrode 173h, the second source electrode 173l, the third source electrode 173c, the first drain electrode 175h, the second drain electrode 175l, and the third drain electrode 175c and the ohmic contacts under the data conductor except for channel regions between the source electrodes 173h, 173l, and 173c and the drain electrodes 175h, 175l, and 175c.

The first semiconductor 154h has an exposed portion that is not covered by the first source electrode 173h and the first drain electrode 175h between the first source electrode 173h and the first drain electrode 175h. The second semiconductor 154l has an exposed portion that is not covered by the second source electrode 173l and the second drain electrode 175l between the second source electrode 173l and the second drain electrode 175l. The third semiconductor 154c has an exposed portion that is not covered by the third source electrode 173c and the third drain electrode 175c between the third source electrode 173c and the third drain electrode 175c.

A passivation layer 180 is disposed on the data conductor and the semiconductors 154h, 154l, and 154c that are exposed between the source electrodes 173h, 173l, and 173c and the drain electrodes 175h, 175l, and 175c. The passivation layer 180 may be made of an organic insulating material or an inorganic insulating material and may be formed as a single layer or a multilayer.

A plurality of color filters 230 are disposed on the passivation layer 180, and each of the color filters 230 is disposed in each of the pixel areas PXs. Each of the color filters 230 may represent one of the primary colors such as red, green, and blue. The color filters 230 may represent other colors such as cyan, magenta, yellow, and white, and the colors represented by the color filters 230 are not limited to these colors. The color filters 230 may be elongated in the column direction along the data lines 171, and each of the color filters 230 may be disposed between two adjacent data lines 171.

A light blocking member 220 is disposed between adjacent color filters 230. The light blocking member 220 may be formed on a boundary portion of the pixel area

PX and on the thin film transistor to prevent light leakage. The color filters 230 may be separated between the first subpixel area PXa and the second subpixel area PXb, and the light blocking member 220 may be disposed between the first subpixel area PXa and the second subpixel area PXb.

The light blocking member 220 is extended along the gate line 121 and the step-down gate line 123 and expanded upward and downward. The light blocking member 220 includes a horizontal light blocking member that covers a region where the first thin film transistor Qh, the second thin film transistor Ql, the third thin film transistor Qc are positioned, and a vertical light blocking member that is extended along the data line 171. The horizontal light blocking member may be disposed in the first valley V1, and the vertical light blocking member may be disposed in the second valley V2. The color filter 230 may partially overlap the light blocking member 220.

A first passivation layer 240 may be disposed on the color filter 230 and the light blocking member 220. The first passivation layer 240 may be made of an inorganic insulating material such as a silicon nitride (SiNx), a silicon oxide (SiOx), a silicon nitride oxide (SiOxNy), or the like. The first passivation layer 240 protects the light blocking member 220 and the color filter 230 of an organic material. The first passivation layer 240 may be omitted if necessary.

The first passivation layer 240, the light blocking member 220, and the passivation layer 180 have a plurality of first contact holes 185h and a plurality of second contact holes 185l. Each of the first contact holes 185h exposes the wide end portion of the first drain electrode 175h and each of the second contact hole exposes the wide end portion of the second drain electrode 175l.

A pixel electrode 191 is disposed on the first passivation layer 240. The pixel electrode 191 may be made of a transparent metallic material such as an indium-tin oxide (ITO), an indium-zinc oxide (IZO), or the like.

The pixel electrode 191 includes a first subpixel electrode 191h and a second subpixel electrode 191l that are separated from each other and disposed in the pixel area PX to be adjacent to each other in the pixel column direction. The gate line 121 and the step-down gate line 123 are interposed between the first subpixel electrode 191h and the second subpixel electrode 191l. The first valley V1 is disposed between the first subpixel electrode 191h and the second subpixel electrode 191l. The first subpixel electrode 191h is positioned in the first subpixel area PXa, and the second subpixel electrode 191l is positioned in the second subpixel area PXb.

The first subpixel electrode 191h is connected to the first drain electrode 175h through the first contact hole 185h, and the second subpixel electrode 191l is connected to the second drain electrode 175l through the second contact hole 185l. Therefore, when the first thin film transistor Qh and the second thin film transistor Ql are turned on, the first subpixel electrode 191h and the second subpixel electrode 191l are supplied with a data voltage from the first drain electrode 175h and the second drain electrode 175l respectively.

Each of the first subpixel electrode 191h and the second subpixel electrode 191l has a quadrangular outline and includes a cruciform stem part including horizontal stem parts 193h and 193l and vertical stem parts 192h and 192l that intersect the horizontal stem parts 193h and 193l. In addition, each of the first subpixel electrode 191h includes a plurality of minute branch parts 194h and a protruding portion 197h that protrudes downward from an edge of the first subpixel electrode 191h. Each of the second subpixel electrode 191l includes a plurality of minute branch parts 194l and a protruding portion 197l that protrudes upward from an edge of the second subpixel electrode 191l.

The first subpixel electrode 191h and the second subpixel electrode 191l are divided into four sub-regions by the horizontal stem parts 193h and 193l and the vertical stem parts 192h and 192l. The minute branch parts 194h are obliquely extended from the horizontal stem part 193h and the vertical stem part 192h, and the extension direction may form an angle of approximately 45° or 135° with the gate line 121 or the horizontal stem part 193h. The minute branch parts 194l are obliquely extended from the horizontal stem part 193l and the vertical stem part 192l, and the extension direction may form an angle of approximately 45° or 135° with the gate line 121 or the horizontal stem part 193l. In addition, the directions in which the minute branch parts 194h and 194l of two adjacent sub-regions are extended may be orthogonal to each other. The arrangement of the pixel area, the structure of the thin film transistor, and the shape of the pixel electrode that are described above are merely examples, and various modifications may be applicable.

A common electrode 270 is disposed on the pixel electrode 191 to be spaced apart from the pixel electrode 191 at a predetermined distance. The microcavity 305 is formed between the pixel electrode 191 and the common electrode 270. The microcavity 305 is enclosed by the pixel electrode 191 and the common electrode 270. A width and an area of the microcavity 305 may be variously changed in accordance with a size and a resolution of the display device.

The common electrode 270 may be made of a transparent metallic material such as an indium-tin oxide (ITO), an indium-zinc oxide (IZO), or the like. A predetermined voltage may be applied to the common electrode 270, and an electric field may be formed between the pixel electrode 191 and the common electrode 270.

The common electrode 270 includes a first common electrode 270a and second common electrode 270b that are applied with different common voltages. The first common electrode 270a and the second common electrode 270b respectively have a stripe shape that is extended in the pixel row direction. In other words, each of the first common electrode 270a and the second common electrode 270b has a rectangle shape having a horizontal side longer than a vertical side.

The first common electrode 270a and the second common electrode 270b are disposed in turns along the pixel column direction. For instance, the first common electrode 270a may be disposed on the plurality of microcavities positioned at Nth row, and the second common electrode 270b may be disposed on the plurality of microcavities positioned at N+1^{th} row. Accordingly, the first common electrode 270a and the second common electrode 270b may alternate with each other in the pixel column direction.

According to an exemplary embodiment of the present disclosure, a first common voltage is applied to the first common electrode 270a, and a second common voltage is applied to the second common electrode 270b. The first common voltage may be greater than the second common voltage.

A voltage difference formed between each subpixel electrode and the common electrode of a liquid crystal display device will be described according to an exemplary embodiment of the present disclosure. According to one embodiment, a higher voltage is applied to the first subpixel electrode 191h than a voltage applied to the second subpixel electrode 191l. The first subpixel electrode 191h may include a liquid crystal capacitor by overlapping the first common electrode 270a or the second common electrode 270b. The first subpixel electrode 191h and the first common electrode 270a may include a first liquid crystal capacitor, and the first subpixel electrode 191h and the second common electrode 270b may include a second liquid crystal capacitor. A charging value of the second liquid crystal capacitor is greater than that of the first liquid crystal capacitor.

According to one embodiment, the first subpixel electrode 191h is applied with 15V, the first common voltage is 7V, and the second common voltage is 6V. The first liquid crystal capacitor formed by the first subpixel electrode 191h and the first common electrode 270a has a charging value of 8V, and the second liquid crystal capacitor formed by the first subpixel electrode 191h and the second common electrode 270b has a charging value of 9V. Accordingly, the charging value of the second liquid crystal capacitor is greater than that of the first liquid crystal capacitor.

According to another embodiment, the second subpixel electrode 191l includes the liquid crystal capacitor by overlapping the first common electrode 270a or the second common electrode 270b. The second subpixel electrode 191l and the first common electrode 270a may include a third liquid crystal capacitor, and the second subpixel electrode 191l and the second common electrode 270b may include a fourth liquid crystal capacitor. A charging value of the fourth liquid crystal capacitor is greater than that of the third liquid crystal capacitor.

According to yet another embodiment, the second subpixel electrode 191l is applied with 11V when the first common voltage is 7V, and the second common voltage is 6V. The third liquid capacitor formed by the second subpixel electrode 191l and the first common electrode 270a has a charging value of 4V, and the fourth liquid crystal capacitor formed by the second subpixel electrode 191l and the second common electrode 270b has a charging value of 5V. Accordingly, the charging value of the fourth liquid crystal capacitor is greater than that of the third liquid crystal capacitor.

As described above, the charging values of the first, second, third and fourth liquid crystal capacitors may be different from each other. Voltages applied between the first and the second subpixel electrodes, and the first and second common electrodes may have four different values.

According to an exemplary embodiment of the present disclosure, one pixel may include the first liquid crystal capacitor, the second liquid crystal capacitor, the third liquid crystal capacitor, and the fourth liquid crystal capacitor that have different charging values respectively. Thus, angles of the liquid crystal molecules disposed in each of liquid crystal capacitor are tilted with different angles, thereby making the luminance of the liquid crystal capacitors different from each other. Therefore, if the voltages of the first liquid crystal capacitor, the second liquid crystal capacitor, the third liquid crystal capacitor, and the fourth liquid crystal capacitor are appropriately adjusted, an image viewed from a side may be displayed similar to an image viewed from a front, thereby providing an improved side visibility. Accordingly, the liquid crystal display device according to an exemplary embodiment of the present disclosure may have adjustable and an improved side visibility.

A first alignment layer 11 is disposed on the pixel electrode 191. The first alignment layer 11 may be disposed on the first passivation layer 240 that is not covered by the pixel electrode 191. A second alignment layer 21 is disposed under the common electrode 270 to face the first alignment layer 11.

The first alignment layer 11 and the second alignment layer 21 may be formed as vertical alignment layers, and made of an alignment material such as polyamic acide, polysiloxane, polyimide, or the like. The first and second alignment layers 11 and 21 may be connected to each other at an edge of the pixel area PX.

A liquid crystal layer that is formed of liquid crystal molecules 310 is disposed in the microcavity 305 positioned between the pixel electrode 191 and the common electrode 270. The liquid crystal molecules 310 have negative dielectric anisotropy, and may stand on the substrate 110 in a vertical direction when no electric field is applied. Accordingly, the liquid crystal molecules 310 are vertically aligned.

When a data voltage is applied, the first subpixel electrode 191h and the second subpixel electrode 191l generate an electric field in cooperation with the common electrode 270 so that a direction of the liquid crystal molecules 310 positioned in the microcavity 305 between the two electrodes 191 and 270 is adjusted. In accordance with the direction of the liquid crystal molecules 310, which is adjusted as described above, luminance of a light that passes through the liquid crystal display device is altered.

A second passivation layer 350 may be further disposed on the common electrode 270. The second passivation layer 350 may be made of an inorganic insulating material such as a silicon nitride (SiNx), a silicon oxide (SiOx), a silicon nitride oxide (SiOxNy), or the like, or may be omitted if necessary.

The roof layer 360 is disposed on the second passivation layer 350. The roof layer 360 may be made of an organic material. The microcavity 305 is disposed under the roof layer 360. The roof layer 360 may be hardened by a curing process to maintain a shape of the microcavity 305. The roof layer 360 is formed to be spaced apart from the pixel electrode 191, and the microcavity 305 is interposed therebetween.

The roof layer 360 is formed along the pixel row in each of the pixel areas PX and at each of the second valleys V2, but is not formed in the first valley V1. The roof layer 360 is not formed between the first subpixel areas PXa and the second subpixel areas PXb. In each of the first subpixel areas PXa and the second subpixel areas PXb, the microcavity 305 are formed under the roof layers 360 respectively. The microcavity 305 is not formed under the roof layer 360 in the second valley V2, but the roof layer 360 is protruded toward the substrate 110 to fill the second valley V2. Thus, a thickness of the roof layer 360 positioned in the second valley V2 may be larger than a thickness of the roof layer 360 positioned in each of the first subpixel areas PXa and the second subpixel areas PXb. The microcavity 305 has an upper surface and side surfaces that are covered by the roof layer 360.

The roof layer 360, the second passivation layer 350, and the common electrode 270 have injection holes 307 that expose a part of the microcavity 305. The injection holes 307 may be formed at edges of the first subpixel area PXa and the second subpixel area PXb to face each other. The injection holes 307 may be formed to expose lateral sides of the microcavity 305 at a lower side of the first subpixel area PXa and an upper side of the second subpixel area PXb. The microcavity 305 is exposed by the injection holes 307 so that an alignment agent, a liquid crystal material, or the like may be injected into the microcavity 305 through the injection holes 307.

A third passivation layer 370 is disposed on the roof layer 360. An encapsulation layer 390 is disposed on the third passivation layer 370. The encapsulation layer 390 blocks the injection holes 307 that expose a part of the microcavity 305. The encapsulation layer 390 seals the microcavity 305 to prevent the liquid crystal molecules 310 that is enclosed in the microcavity 305 from spilling out. Because the encapsulation layer 390 contacts with the liquid crystal molecules 310, the encapsulation layer 390 may be made of a material that does not react with the liquid crystal molecules 310.

The encapsulation layer 390 may be formed as a multilayer such as a double layer or a triple layer. The double layer includes two layers made of different materials. The triple layer includes three layers, and materials of the adjacent layers are different from each other. For example, the encapsulation layer 390 may include a layer made of an organic insulating material and a layer made of an inorganic insulating material.

Although not illustrated, polarizers may be further disposed on upper and lower surfaces of the display device. The polarizer may include a first polarizer and a second polarizer. The first polarizer may be attached to a lower surface of the substrate 110, and the second polarizer may be attached on the encapsulation layer 390.

According to another embodiment, common voltages are applied to the common electrodes alternatively. The common electrode includes the first common electrode 270a and the second common electrode 270b. The first common voltage and the second common voltage may be applied to first common electrode 270a and second common electrode 270b alternatively. Specifically, in one frame, the first common electrode is applied to the first common electrode 270a, and the second common voltage is applied to the second common electrode 270b. In the next frame, the second common voltage is applied to the first common electrode 270a, and the first common voltage is applied to the second common electrode 270b. The liquid crystal display device may prevent a same voltage from being continuously applied to a same region, thereby eliminating display defects such as afterimage.

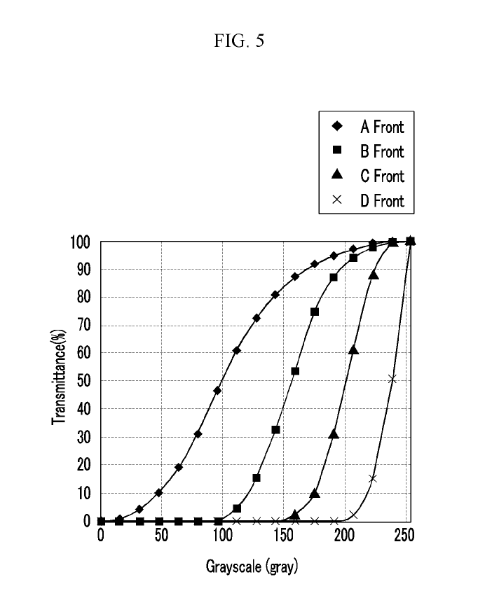

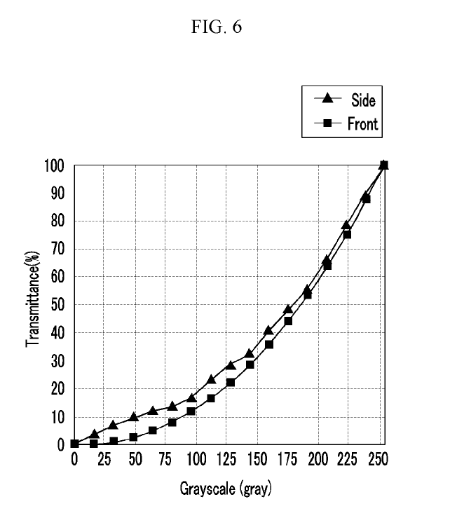

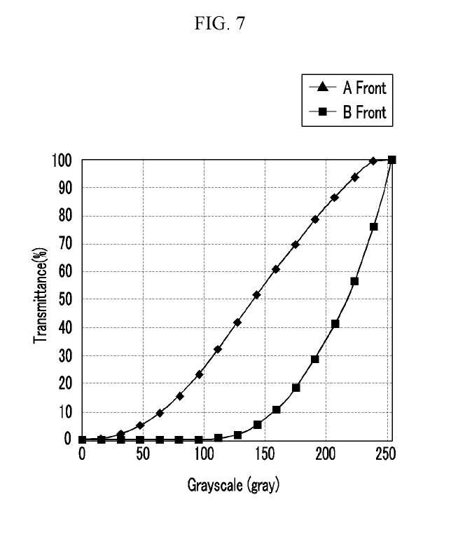

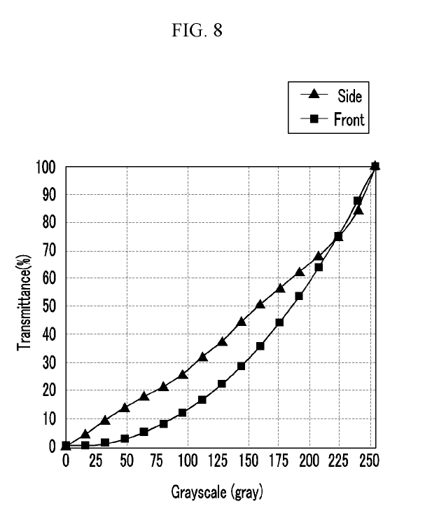

Referring to FIGS. 5-8, transmittance of the liquid crystal display device according to an exemplary embodiment of the present disclosure and a comparative example will be described. FIGS. 5 and 6 are transmittance graphs according to an exemplary embodiment of the present disclosure, and FIGS. 7 and 8 are transmittance graphs according to a comparative example.

Referring to FIG. 5, transmittances as a function of an applied grayscale in the first liquid crystal capacitor (A front, 49V), the second liquid crystal capacitor (B front, 48V), the third liquid crystal capacitor (C front, 45V) and the fourth liquid crystal capacitor (D front, 44V) are respectively illustrated. Since each of the liquid crystal capacitors is charged with a different voltage at the same applied grayscale, the curves of transmittance as a function of the applied grayscale are different for the liquid crystal capacitors.

The liquid crystal display device according to an exemplary embodiment of the present disclosure includes four regions having different luminance in each pixel area. Thus, as shown in FIG. 6, the liquid crystal display device according to an exemplary embodiment of the present disclosure provides a transmittance for a side view almost the same as that of a front view. In other words, a liquid crystal display device according to an exemplary embodiment of the present disclosure has an improved side visibility to match with a front visibility. It is noted that a front visibility of a liquid crystal display device may be worse that a side visibility. In this case, the transmittance for a front view is improved to match that of a side view.

Referring to FIGS. 7 and 8, the transmittance of the liquid crystal display device according to a comparative example will be described. As illustrated in FIG. 7, the liquid crystal display device according to a comparative example includes two regions that have different luminance in each pixel area. A front region A represents the transmittance of a high grayscale region, and a front region B represents the transmittance of a low grayscale region. As shown by FIG. 8, the liquid crystal display device according to a comparative example has a side visibility that is significantly different from a front visibility in a low grayscale range and a medium grayscale range.

In sum, the liquid crystal display device according to an exemplary embodiment of the present disclosure including four regions of different luminance for each pixel area provides an improved side visibility and transmittance. While the present disclosure has been described in connection with exemplary embodiments, it is to be understood by a person of ordinary skill in the art that the present disclosure is not limited to the disclosed embodiments, but, on the contrary, is intended to cover various modifications and equivalent arrangements included within the spirit and scope of the appended claims.

What is claimed is:

1. A liquid crystal display device comprising:
a substrate;
a thin film transistor connected to a gate line and a data line that are insulated from and intersected with each other on the substrate;
a pixel electrode including a first subpixel electrode and a second subpixel electrode that are connected to the thin film transistor;
a common electrode spaced apart from the pixel electrode with a plurality of microcavities, the plurality of microcavities being disposed on the pixel electrode and interposed between the common electrode and the pixel electrode;
a roof layer disposed on the common electrode; and
a liquid crystal layer that includes liquid crystal molecules filling the plurality of microcavities,
wherein the common electrode includes a first common electrode and a second common electrode, and a voltage applied to the first common electrode and a voltage applied to the second common electrode are different from each other.

2. The liquid crystal display device of claim 1, wherein:
the first common electrode and the second common electrode are extended in a row direction.

3. The liquid crystal display device of claim 1, wherein:
the first common electrode and the second common electrode are alternatively disposed in a column direction.

4. The liquid crystal display device of claim 1, wherein:
the thin film transistor includes a first thin film transistor, a second thin film transistor, and a third thin film transistor that is connected to the second thin film transistor,
the first subpixel electrode is connected to the first thin film transistor, and
the second subpixel electrode is connected to the second thin film transistor.

5. The liquid crystal display device of claim 4, wherein:
the first common voltage is applied to the first common electrode, and the second common voltage is applied to the second common electrode, and
the first common voltage is greater than the second common voltage.

6. The liquid crystal display device of claim 5, wherein:
the first subpixel electrode and the first common electrode form a first liquid crystal capacitor, and the first subpixel electrode and the second common electrode form a second liquid crystal capacitor, and
a charging value of the second liquid crystal capacitor is greater than a charging value of the first liquid crystal capacitor.

7. The liquid crystal display device of claim 5, wherein:
the second subpixel electrode and the first common electrode form a third liquid crystal capacitor, and the second subpixel electrode and the second common electrode form a fourth liquid crystal capacitor, and
a charging value of the fourth liquid crystal capacitor is greater than a charging value of the third liquid crystal capacitor.

8. The liquid crystal display device of claim 4, wherein:
the first common voltage and the second common voltage are applied to the first common electrode and the second common electrode alternatively.

9. The liquid crystal display device of claim 1, further comprising:
a color filter;
a gate insulating layer disposed on the gate line;
a first passivation layer disposed on the data line;
a second passivation layer disposed on the common electrode; and
a third passivation layer disposed on the color filter.

10. The liquid crystal display device of claim 9, wherein:
at least one of the second passivation layer and the third passivation layer comprises a silicon nitride, a silicon oxide, or a silicon nitride oxide.

11. The liquid crystal display device of claim 1, further comprising an encapsulation layer, wherein:
the common electrode and the roof layer have an injection hole configured to expose a part of the pluralities of microcavities, and
the encapsulation layer is disposed on the roof layer and is configured to cover the injection hole and to seal the pluralities of microcavities.

12. The liquid crystal display device of claim 1, wherein:
the pluralities of microcavities are arranged in a form of a matrix; and
a first valley is positioned between two adjacent rows of the pluralities of microcavities.

13. The liquid crystal display device of claim 1, wherein:
each of the first subpixel electrode and the second subpixel electrode includes a cruciform stem part and a plurality of minute branch parts; and
the common electrode is in a plane shape.
